(19) United States
(12) Patent Application Publication
(10) Pub. No.: US 2019/0286135 A1
(43) Pub. Date: Sep. 19, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Naoto Yasuda, Wako-shi (JP); Takafumi Hirose, Wako-shi (JP); Yuki Oshitani, Tokyo (JP); Susumu Iwamoto, Tokyo (JP)

(21) Appl. No.: 16/295,006

(22) Filed: Mar. 7, 2019

(30) Foreign Application Priority Data
Mar. 14, 2018 (JP) 2018-046721

(51) Int. Cl. G05D 1/00; G05D 1/02

(52) U.S. Cl. CPC G05D 1/0088; G05D 1/0246; G05D 1/0287; G05D 1/0223; G05D 1/0257

(57) ABSTRACT

A vehicle control device including: a recognition unit (130) that recognizes a surrounding situation of a subject vehicle and recognizes a state of a vehicle occupant having boarded the subject vehicle; and a driving control unit (140 or 160) that controls steering and acceleration/deceleration of the subject vehicle on the basis of the surrounding situation recognized by the recognition unit, wherein, in a case in which the subject vehicle is parked, the driving control unit sets a parking completion state in a case in which it is recognized by the recognition unit that no vehicle occupant has boarded the subject vehicle to be different from a parking completion state in a case in which it is recognized by the recognition unit that a vehicle occupant has boarded the subject vehicle.

### CROSS-REFERENCE TO RELATED APPLICATION

Priority is claimed on Japanese Patent Application No. 2018-046721, filed Mar. 14, 2018, the content of which is incorporated herein by reference.

### BACKGROUND

### Field of the Invention

The present invention relates to a vehicle control device, a vehicle control method, and a storage medium.

### Description of Related Art

In recent years, automated control of vehicles has been researched. In relation to this, technologies for causing a vehicle to run to a destination even when there is no vehicle occupant are known (for example, Japanese Unexamined Patent Application, First Publication No. 2016-115364).

### SUMMARY

However, in conventional technologies, control of parking a vehicle that can run without any vehicle occupant is not considered.

An aspect of the present invention is realized in consideration of such situations, and one object thereof is to provide a vehicle control device, a vehicle control method, and a storage medium capable of executing more appropriate parking control on the basis of presence/absence of a boarding occupant of a vehicle.

A vehicle control device, a vehicle control method, and a storage medium according to the present invention employ the following configurations.

(1): A vehicle control device according to one aspect of the present invention is a vehicle control device including: a recognition unit that recognizes a surrounding situation of a subject vehicle and recognizes a state of a vehicle occupant having boarded the subject vehicle; and a driving control unit that controls steering and acceleration/deceleration of the subject vehicle on the basis of the surrounding situation recognized by the recognition unit, wherein, in a case in which the subject vehicle is parked, the driving control unit sets a parking completion state in a case in which it is recognized by the recognition unit that no vehicle occupant has boarded the subject vehicle to be different from a parking completion state in a case in which it is recognized by the recognition unit that a vehicle occupant has boarded the subject vehicle.

(2): In the aspect (1) described above, in a case in which it recognized that no vehicle occupant has boarded the subject vehicle in a case in which the subject vehicle is parked, the driving control unit sets a distance between a surrounding object recognized by the recognition unit and the subject vehicle to be shorter than in a case in which it is determined that a vehicle occupant has boarded the subject vehicle.

(3): In the aspect (2) described above, the distance between the surrounding object and the subject vehicle is a distance between at least one door among a plurality of doors provided in the subject vehicle and the surrounding object.

(4): In the aspect (1) described above, the recognition unit recognizes whether another vehicle that is one of surrounding objects of the subject vehicle is an automated driving vehicle or a non-automated driving vehicle, and, in a case in which the subject vehicle is parked, the driving control unit sets a distance to the subject vehicle to be longer in a case in which it is recognized that no vehicle occupant has boarded the subject vehicle, and the another vehicle is a non-automated driving vehicle than in a case in which it is recognized that no vehicle occupant has boarded the subject vehicle, and the another vehicle is an automated driving vehicle.

(5): A vehicle control method according to one aspect of the present invention is a vehicle control method using a vehicle control device, the vehicle control method including: recognizing a surrounding situation of a subject vehicle and recognizing a state of a vehicle occupant having boarded the subject vehicle; controlling steering and acceleration/deceleration of the subject vehicle on the basis of the recognized surrounding situation; and setting a parking completion state in a case in which it is recognized that no vehicle occupant has boarded the subject vehicle to be different from a parking completion state in a case in which it is recognized that a vehicle occupant has boarded the subject vehicle in a case in which the subject vehicle is parked.

(6): A storage medium according to one aspect of the present invention is a computer-readable non-transitory storage medium having a program stored thereon, the program causing a vehicle control device to execute: recognizing a surrounding situation of a subject vehicle and recognizing a state of a vehicle occupant having boarded the subject vehicle; controlling steering and acceleration/deceleration of the subject vehicle on the basis of the recognized surrounding situation; and setting a parking completion state in a case in which it is recognized that no vehicle occupant has boarded the subject vehicle to be different from a parking completion state in a case in which it is recognized that a vehicle occupant has boarded the subject vehicle in a case in which the subject vehicle is parked.

According to the aspects (1) to (6) described above, more appropriate parking control can be performed on the basis of presence/absence of a boarding occupant of a vehicle.

### BRIEF DESCRIPTION OF THE DRAWINGS

FIG. 1 is a configuration diagram of a vehicle system using a vehicle control device according to an embodiment;

FIG. 2 is a functional configuration diagram of a first control unit and a second control unit;

FIG. 3 is a diagram showing a process of a parking area recognizing unit;

FIG. 4 is a diagram showing a process of an other vehicle determining unit;

FIG. 5 is a diagram showing a process of a parking driving control unit that parks a subject vehicle in a parking area dedicated for automated driving vehicles;

FIG. 6 is a diagram showing a process of a parking driving control unit that parks a subject vehicle M in a garage;

FIG. 7 is a flowchart showing the flow of a process executed by an automated driving control device according to an embodiment; and

FIG. 8 is a diagram showing one example of the hardware configuration of an automated driving control device according to an embodiment.

### DESCRIPTION OF EMBODIMENTS

Hereinafter, a vehicle control device, a vehicle control method, and a storage medium according to an embodiment of the present invention will be described with reference to the drawings. A vehicle control device according to an embodiment is applied to an automated driving vehicle. Automated driving, for example, is execution of driving control by controlling one or both of steering and acceleration/deceleration of a vehicle. A vehicle control device according to an embodiment can perform automated driving according to an unmanned state or a manned state. Here, the unmanned state is a state in which no persons including not only a vehicle occupant (driver) operating a driving operator but also vehicle occupants (non-drivers) not operating a driving operator have boarded a vehicle. On the other hand, the manned state is a state in which one or more vehicle occupants including a driver and a non-driver has boarded a vehicle. Hereinafter, although a case in which left-side traffic regulations are applied will be described, the left side and the right side may be interchanged in a case in which a rule of right-side traffic is applied.

### [Entire Configuration]

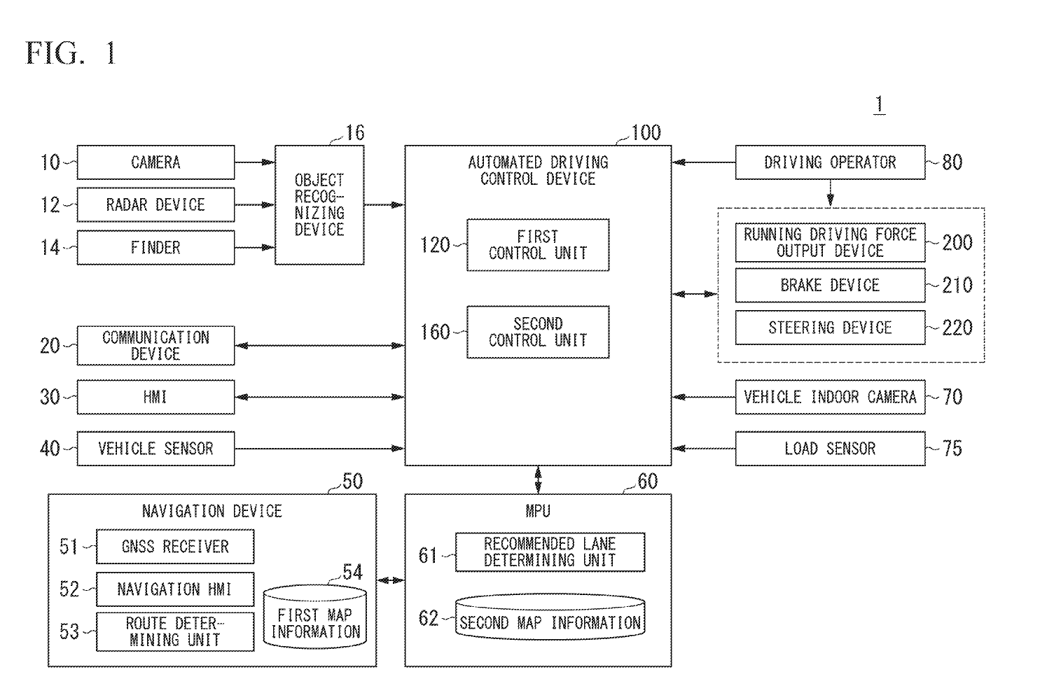

FIG. 1 is a configuration diagram of a vehicle system 1 using a vehicle control device according to an embodiment. A vehicle in which the vehicle system 1 is mounted is, for example, a vehicle having two wheels, three wheels, four wheels, or the like, and a driving source thereof is an internal combustion engine such as a diesel engine or a gasoline engine, an electric motor, or a combination thereof. The electric motor operates using power generated using a power generator connected to an internal combustion engine or power discharged from a secondary cell or a fuel cell.

The vehicle system 1, for example, includes a camera 10, a radar device 12, a finder 14, an object recognizing device 16, a communication device 20, a human machine interface (HMI) 30, a vehicle sensor 40, a navigation device 50, a map positioning unit (MPU) 60, a vehicle indoor camera 70, a load sensor 75, a driving operator 80, an automated driving control device 100, a running driving force output device 200, a brake device 210, and a steering device 220. Such devices and units are interconnected using a multiplex communication line such as a controller area network (CAN) communication line, a serial communication line, a radio communication network, or the like. The configuration shown in FIG. 1 is merely one example, and thus parts of the configuration may be omitted or other additional components may be added. The automated driving control device 100 is one example of a “vehicle control device.”

The camera 10, for example, is a digital camera using a solid-state imaging device such as a charge coupled device (CCD) or a complementary metal oxide semiconductor (CMOS). The camera 10 is installed at an arbitrary place on a vehicle in which the vehicle system 1 is mounted (hereinafter referred to as a subject vehicle M). In the case of forward imaging, the camera 10 is installed on an upper part of a front windshield, a rear face of a rear-view mirror, or the like. The camera 10, for example, repeatedly images the vicinity of the subject vehicle M periodically. The camera 10 may be a stereo camera.

The radar device 12 emits radio waves such as millimeter waves to the vicinity of the subject vehicle M and detects at least a position of (a distance to and an azimuth of) an object by detecting radio waves (reflected waves) reflected by the object. The radar device 12 is installed at an arbitrary place on the subject vehicle M. The radar device 12 may detect a position and a speed of an object using a frequency modulated continuous wave (FM-CW) system.

The finder 14 is a light detection and ranging (LIDAR) device. The finder 14 emits light to the vicinity of the subject vehicle M and measures scattered light. The finder 14 detects a distance with respect to a target on the basis of a time from light emission to light reception. The emitted light, for example, is pulse-form laser light. The finder 14 is mounted at an arbitrary position on the subject vehicle M.

The object recognizing device 16 may perform a sensor fusion process on results of detection using some or all of the camera 10, the radar device 12, and the finder 14, thereby allowing recognition of a position, a type, a speed, and the like of an object. The object recognizing device 16 outputs a result of recognition to the automated driving control device 100. The object recognizing device 16 may output results of detection using the camera 10, the radar device 12, and the finder 14 to the automated driving control device 100 as they are. The object recognizing device 16 may be omitted from the vehicle system 1. The camera 10 includes an infrared camera imaging changes in the surface temperature of an object in addition to a camera imaging a general image. Switching between general imaging and infrared imaging may be performed using functions included in the camera 10.

The communication device 20, for example, communicates with other vehicles present in the vicinity of the subject vehicle M using a cellular network, a Wi-Fi network, Bluetooth (registered trademark), dedicated short range communication (DSRC), or the like or communicates with various server apparatuses through a radio base station.

The HMI 30 presents various types of information to an occupant of the subject vehicle M and receives an input operation performed by a vehicle occupant. The HMI 30 includes various display devices, a speaker, a buzzer, a touch panel, switches, keys, light emitting devices disposed inside a vehicle cabin, and the like.

The vehicle sensor 40 includes a vehicle speed sensor that detects a speed of the subject vehicle M, an acceleration sensor that detects an acceleration, a yaw rate sensor that detects an angular velocity around a vertical axis, an azimuth sensor that detects the azimuth of the subject vehicle M, and the like. The acceleration sensor, for example, may include a sensor that detects a longitudinal acceleration and a lateral acceleration. The longitudinal acceleration, for example, is an acceleration with respect to the advancement direction of the subject vehicle M. The lateral acceleration, for example, is an acceleration in a vehicle width direction of the subject vehicle M with respect to the advancement direction of the subject vehicle M. The vehicle sensor 40 may include a contact detection sensor that detects contact/no-contact from the outside and the strength of a contact at an arbitrary position of a body part of the subject vehicle M. The vehicle sensor 40 may include a vibration sensor that detects a vibration of the subject vehicle M and a sound detection sensor that detects a sound generated from the subject vehicle M or near the subject vehicle M.

The navigation device 50, for example, includes a global navigation satellite system (GNSS) receiver 51, a navigation HMI 52, and a route determining unit 53. The navigation device 50 stores first map information 54 in a storage device such as a hard disk drive (HDD) or a flash memory. The GNSS receiver 51 identifies a position of a subject vehicle M on the basis of signals received from GNSS satellites. The position of the subject vehicle M may be identified or complemented by an inertial navigation system (INS) using an output of the vehicle sensor 40. The navigation HMI 52 includes a display device, a speaker, a touch panel, a key, and the like. A part or the whole of the navigation HMI 52 and the HMI 30 described above may be configured to be shared. The route determining unit 53, for example, determines a route from a position of the subject vehicle M identified by the GNSS receiver 51 (or an input arbitrary position) to a destination input by a vehicle occupant using the navigation HMI 52 in the manned state or a destination transmitted from an external communication terminal and received by the communication device 20 in the unmanned state (hereinafter referred to as a route on a map) by referring to the first map information 54. The first map information 54, for example, is information in which a road form is represented by respective links representing roads and respective nodes connected using the links. The first map information 54 may include information relating to road signs for the links. The first map information 54 may include a curvature of each road, point of interest (POI) information, and the like. The route on the map is output to the MPU 60. The navigation device 50 may perform route guidance using the navigation HMI 52 on the basis of the route on the map. The navigation device 50, for example, may be realized by a function of a terminal device such as a smartphone or a tablet terminal held by a vehicle occupant. The navigation device 50 may transmit a current location and a destination to a navigation server through the communication device 20 and acquire a route equivalent to the route on the map received from the navigation server.

The MPU 60, for example, includes a recommended lane determining unit 61 and stores second map information 62 in a storage device such as an HDD or a flash memory. The recommended lane determining unit 61 divides the route on the map provided from the navigation device 50 into a plurality of blocks (for example, divides the route into blocks of 100 [m] in the advancement direction of the vehicle) and determines a recommended lane for each block by referring to the second map information 62. The recommended lane determining unit 61 determines in which of lanes numbered from the left side to run. In a case in which there is a branching place in the route on the map, the recommended lane determining unit 61 determines a recommended lane such that the subject vehicle M can run along a reasonable route for advancement to a branching destination.

The second map information 62 is map information having higher accuracy than the first map information 54. The second map information 62, for example, includes information on the centers of respective lanes, information on boundaries between lanes, or the like. In addition, in the second map information 62, road information, traffic regulations information, address information (addresses and postal codes), facility information, telephone number information, and the like may be included. The second map information 62 may be updated as needed by the communication device 20 communicating with another device.

The vehicle indoor camera 70, for example, images the inside of the vehicle cabin of the subject vehicle M. For example, the vehicle indoor camera 70 performs imaging such that an area near each seat inside the vehicle cabin on which a vehicle occupant sits is in an angle of view. The vehicle indoor camera 70, for example, is a digital camera using a solid-state imaging device such as a CCD or a CMOS. The vehicle indoor camera 70, for example, periodically images the inside of the vehicle cabin of the subject vehicle M and outputs a captured image to the automated driving control device 100.

The load sensor 75 detects a load applied to each seat inside the vehicle cabin and outputs results of detection to the automated driving control device 100.

The driving operator 80, for example, includes an acceleration pedal, a brake pedal, a shift lever, a steering wheel, a steering wheel variant, a joystick, and other operators. A sensor detecting the amount of an operation or the presence/absence of an operation is installed in the driving operator 80, and a result of the detection is output to the automated driving control device (vehicle control device) 100 or some or all of the running driving force output device 200, the brake device 210, and the steering device 220. In the steering wheel, a grip sensor detecting whether or not the steering wheel is being gripped by a vehicle occupant may be mounted.

The automated driving control device 100, for example, includes a first control unit 120 and a second control unit 160. Each of such constituent elements, for example, is realized by a hardware processor such as a central processing unit (CPU) executing a program (software). Some or all of these constituent elements may be realized by hardware (a circuit unit; including circuitry) such as a large scale integration (LSI), an application specific integrated circuit (ASIC), a field-programmable gate array (FPGA), or a graphics processing unit (GPU) or may be realized by software and hardware in cooperation. The program may be stored in a storage device such as a hard disk drive (HDD) or a flash memory of the automated driving control device 100 in advance or may be stored in a storage medium such as a DVD or a CD-ROM that can be loaded or unloaded and installed in an HDD or a flash memory of the automated driving control device 100 by loading the storage medium into a drive device. A combination of the action plan generating unit 140 and the second control unit 160 is one example of a “driving control unit.” The driving control unit, for example, executes driving control by controlling steering and acceleration/deceleration of the subject vehicle M on the basis of the surrounding situation recognized by the recognition unit 130.

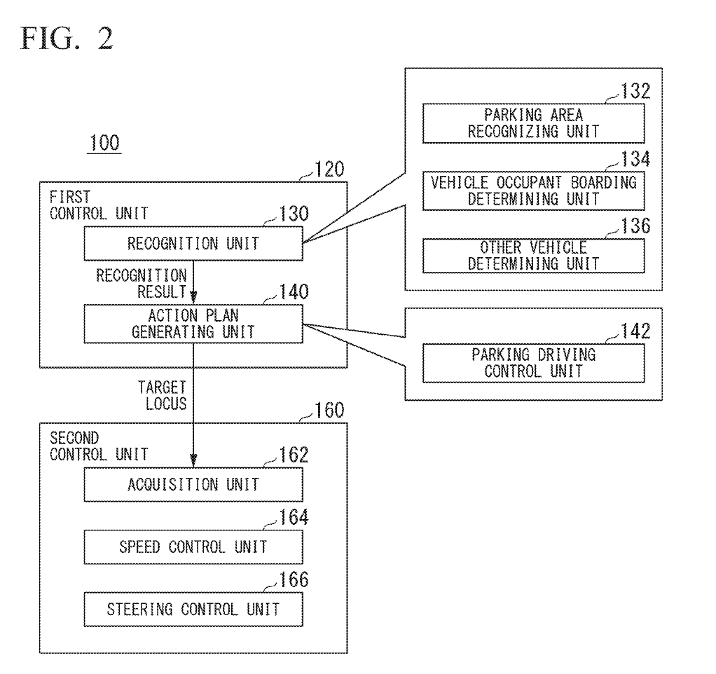

FIG. 2 is a functional configuration diagram of the first control unit 120 and the second control unit 160. The first control unit 120, for example, includes a recognition unit 130 and an action plan generating unit 140. The recognition unit 130, for example, includes a parking area recognizing unit 132, a vehicle occupant boarding determining unit 134, and an other vehicle determining unit 136. The action plan generating unit 140, for example, includes a parking driving control unit 142.

The first control unit 120, for example, simultaneously realizes functions using artificial intelligence (AI) and functions using a model provided in advance. For example, a function of “recognizing an intersection” may be realized by executing recognition of an intersection using deep learning or the like and recognition based on conditions given in advance (a traffic light, road signs, and the like that can be used for pattern matching are present) at the same time and comprehensively evaluating both recognitions by assigning scores to them. Accordingly, the reliability of automated driving is secured.

The recognition unit 130 recognizes states such as a position, orientation, a speed, an acceleration, and the like of each object present in the vicinity of the subject vehicle M on the basis of information input from the camera 10, the radar device 12, and the finder 14 through the object recognizing device 16. Objects, for example, include persons such as pedestrians, moving bodies such as other vehicles, construction sites, and obstacles on a road such as loads fallen down from a loaded vehicle. Objects may include a curbstone, a median strip, a side ditch, a guard rail, a wall, and the like. The position of an object, for example, is recognized as a position in an absolute coordinate system having a representative point (the center of gravity, the center of a driving shaft, or the like) of the subject vehicle M as its origin and is used for control. The position of an object may be represented as a representative point such as the center of gravity or a corner of an object or may be represented in a representative area. A “state” of an object, for example, may include an acceleration, a jerk, or an “action state” (for example, whether or not the object is changing lanes or is to change lanes), in a case in which the object is another vehicle.

The recognition unit 130, for example, recognizes a lane in which the subject vehicle M is running (running lane). For example, the recognition unit 130 may recognize a running lane by comparing a pattern (for example, an arrangement of solid lines and broken lines) of road partition lines acquired from the second map information 62 with a pattern of road partition lines in the vicinity of the subject vehicle M recognized from an image captured by the camera 10. The recognition unit 130 may recognize a running lane by recognizing running road boundaries (road boundaries) including road partition lines, road shoulders, roadside strips, curbstones, a median strip, guard rails, and the like instead of road partition lines. In this recognition, the location of the subject vehicle M acquired from the navigation device 50 or a processing result acquired by the INS may be taken into account as well. The recognition unit 130 may recognize a width, a height, a shape, a type (for example, a model of another vehicle), and the like of an object on the basis of an image captured by the camera 10. The recognition unit 130 recognizes road signs, a red light, a tollgate, a road structure, and other road events.

When recognizing a running lane, the recognition unit 130 recognizes a position and a posture of the subject vehicle M with respect to the running lane. The recognition unit 130, for example, may recognize a deviation of a reference point (for example, the center of gravity) of the subject vehicle M from the center of the lane and an angle formed with respect to a line aligned along the center of the lane in the advancement direction of the subject vehicle M as a relative position and a posture of the subject vehicle M with respect to the running lane. Instead of this, the recognition unit 130 may recognize the position of the reference point of the subject vehicle M with respect to one side end part (a road partition line or a road boundary) of the running lane or the like as a relative position of the subject vehicle M with respect to the running lane. The recognition unit 130 may recognize structures (for example, an electricity pole, a median strip, and the like) on the road on the basis of the first map information 54 or the second map information 62. The functions of the parking area recognizing unit 132, the vehicle occupant boarding determining unit 134, and the other vehicle determining unit 136 of the recognition unit 130 will be described later.

The action plan generating unit 140 automatically (independently of a driver's operation) generates a target locus along which the subject vehicle M will run in the future such that the subject vehicle basically can run on a recommended lane determined by the recommended lane determining unit 61 and can respond to a surrounding situation of the subject vehicle M. The target locus, for example, includes a speed element. For example, the target locus is represented by sequentially aligning places (locus points) at which the reference point (for example, the center of gravity G) of the subject vehicle M will arrive. A locus point is a place at which the subject vehicle M will arrive at respective predetermined running distances (for example, about every several [m]) as distances along the road, and separately from that, a target speed and a target acceleration for each of predetermined sampling times (for example, several fractions of a [sec]) are generated as a part of the target locus. A target speed for each sampling time, for example, is set on the basis of a maximum target speed that is determined for each road through which the subject vehicle passes. The target speed of the higher rank, for example, may be set on the basis of a limit speed or a legal speed or may be set arbitrarily or within a predetermined range from a limit speed or a legal speed by the vehicle occupant. A target speed in the claims, for example, corresponds to a maximum target speed. A locus point may be a position at which the subject vehicle M will arrive at a predetermined sampling time for each of the sampling time. In such a case, information of a target speed or a target acceleration is represented using intervals between the locus points.

When a target locus is generated, the action plan generating unit 140 may set an event of automated driving. As events of automated driving, there are a constant-speed running event, a low-speed running-behind event, a lane change event, a branching event, a merging event, an overtaking event, an avoidance event, and the like. The action plan generating unit 140 generates a target locus according to operating events. The functions of the parking driving control unit 142 of the action plan generating unit 140 will be described later.

The second control unit 160 performs control of the running driving force output device 200, the brake device 210, and the steering device 220 such that the subject vehicle M passes along a target locus generated by the action plan generating unit 140 at a scheduled time.

The second control unit 160, for example, includes an acquisition unit 162, a speed control unit 164, and a steering control unit 166. The acquisition unit 162 acquires information of a target locus (locus points) generated by the action plan generating unit 140 and stores the target locus information in a memory (not shown). The speed control unit 164 controls the running driving force output device 200 or the brake device 210 on the basis of a speed element accompanying the target locus stored in the memory. The steering control unit 166 controls the steering device 220 in accordance with a degree of curvature of the target locus stored in the memory. The processes of the speed control unit 164 and the steering control unit 166, for example, are realized by a combination of feed forward control and feedback control. For example, the steering control unit 166 may execute feed forward control according to the curvature of a road in front of the subject vehicle M and feedback control based on a deviation from the target locus in combination.

The running driving force output device 200 outputs a running driving force (torque) used for a vehicle to run to driving wheels. The running driving force output device 200, for example, includes a combination of an internal combustion engine, an electric motor, a transmission, and the like and an electronic control unit (ECU) controlling these components. The ECU controls the components described above in accordance with information input from the second control unit 160 or information input from the driving operator 80.

The brake device 210, for example, includes a brake caliper, a cylinder that delivers hydraulic pressure to the brake caliper, an electric motor that generates hydraulic pressure in the cylinder, and a brake ECU. The brake ECU performs control of the electric motor in accordance with information input from the second control unit 160 or information input from the driving operator 80 such that a brake torque according to a brake operation is output to each vehicle wheel. The brake device 210 may include a mechanism delivering hydraulic pressure generated in accordance with an operation on the brake pedal included in the driving operators 80 to the cylinder through a master cylinder as a backup. The brake device 210 is not limited to the configuration described above and may be an electronically-controlled hydraulic brake device that delivers hydraulic pressure in the master cylinder to a cylinder by controlling an actuator in accordance with information input from the second control unit 160.

The steering device 220, for example, includes a steering ECU and an electric motor. The electric motor, for example, changes the direction of the steering wheel by applying a force to a rack and pinion mechanism. The steering ECU changes the direction of the steering wheel by driving an electric motor in accordance with information input from the second control unit 160 or information input from the driving operator 80.

### [Function of Parking Area Recognizing Unit]

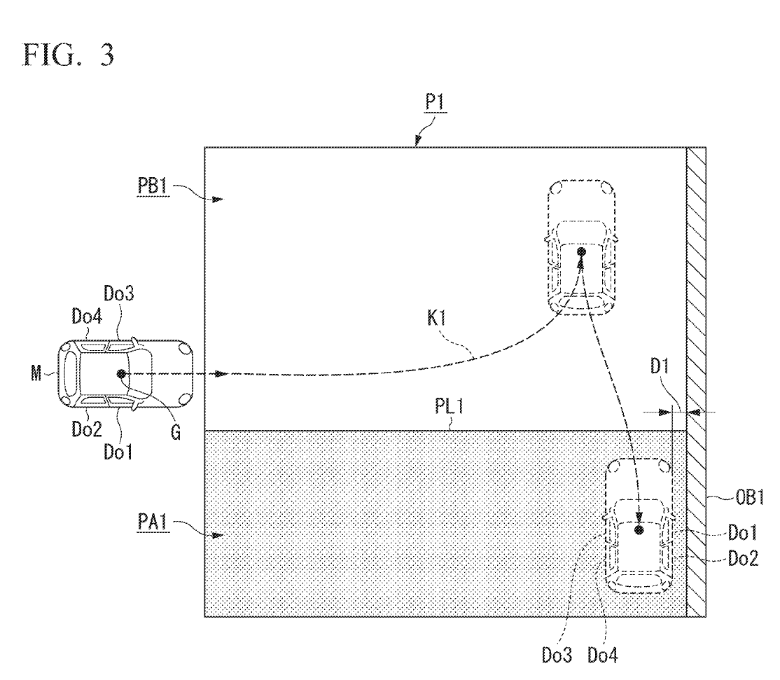

In a case in which parking control for the subject vehicle M is executed by the parking driving control unit 142, the parking area recognizing unit 132 recognizes a parking area in which the subject vehicle M is to be parked. FIG. 3 is a diagram showing a process of the parking area recognizing unit 132. In the example illustrated in FIG. 3, a parking area PA1 in which a vehicle can be parked and a non-parking area PB1 used mainly for a vehicle to move inside the parking lot P1 are included inside a planar parking lot P1. A vehicle can run in the parking area PA1. In the following description, it is assumed that doors Do1 to Do4 through which a vehicle occupant gets in or out are provided on front and rear sides of the left and right sides of the vehicle body in the subject vehicle M.

For example, in a case in which the subject vehicle M arrives at a destination through automated driving, the parking area recognizing unit 132 recognizes a space in which the subject vehicle M is to be parked inside the parking lot P1 on the basis of results of detection acquired using some or all of the camera 10, the radar device 12, and the finder 14. In a case in which a direction for executing parking control is accepted from a vehicle occupant boarded the subject vehicle M or a case in which a direction for parking the subject vehicle M is accepted in accordance with a remote operation from an external communication terminal or the like, the parking area recognizing unit 132 may recognize a space in which the subject vehicle M is to be parked.

In the example shown in FIG. 3, in a case in which the subject vehicle M is parked inside the parking lot P1, the parking area recognizing unit 132 recognizes an outer peripheral shape and a partition line PL1 of the parking lot P1 and a color, a pattern, and the like of the road surface inside the parking lot P1 and recognizes a parking area PA1 and a non-parking area PB1 partitioned using the partition line PL1 on the basis of the outer peripheral shape and the road partition line PL1 that have been recognized. The parking area recognizing unit 132 may refer to the first map information 54, the second map information 62, and the like on the basis of the positional information of the subject vehicle M and recognize a parking area PA1 that is close from the current position of the subject vehicle M.

The parking area recognizing unit 132 may recognize surrounding objects of the subject vehicle M present inside the parking lot P1 or near the parking lot Pl. A surrounding object, for example, is another vehicle present inside the parking lot P1 or a surrounding structure present inside the parking lot P1 or near the parking lot P1. The surrounding structures, for example, include a side wall OB1 disposed in at least a part of the outer peripheral part of the parking lot P1, vehicle wheel stoppers that become parking reference positions of each vehicle to be parked in the parking area PA1, a gate for entry/exit to/from the parking lot Pl, sign boards, and the like. The parking area recognizing unit 132 may recognize surrounding objects and characters, symbols, and the like drawn on a road surface inside the parking lot.

### [Function of Vehicle Occupant Boarding Determining Unit]

In a case in which the parking area PA1 is recognized by the parking area recognizing unit 132, the vehicle occupant boarding determining unit 134 determines whether or not a vehicle occupant has boarded the subject vehicle M. More specifically, the vehicle occupant boarding determining unit 134, first, analyzes an image captured by the vehicle indoor camera 70 and determines whether or not feature information of a face or a body (an upper half body or the like) is included in the image. The feature information of the face or the body, for example, can be extracted using pattern matching using colors and shapes and the like. Then, in a case in which it is determined that feature information of a face or a body is included in the image, the vehicle occupant boarding determining unit 134 determines that a vehicle occupant has boarded the subject vehicle M (in other words, a manned state). On the other hand, in a case in which it is determined that feature information of a face or a body is not included in the image, the vehicle occupant boarding determining unit 134 determines that no vehicle occupant has boarded the subject vehicle M (in other words, an unmanned state).

The vehicle occupant boarding determining unit 134 may determines that a vehicle occupant has boarded the subject vehicle M in a case in which a load value of at least one seat among seats detected by the load sensor 75 is equal to or larger than a threshold. The vehicle occupant boarding determining unit 134 may determine that no vehicle occupant has boarded the subject vehicle M in a case in which load values of all the seats are smaller than a threshold.

For example, the vehicle occupant boarding determining unit 134 may determine a manned state in a case in which a result of determination based on an image captured by the vehicle indoor camera 70 or at least one of results of determination based on the load sensors 75 represents that a vehicle occupant has boarded the subject vehicle M or may determine a manned state in a case in which both the results represent that a vehicle occupant has boarded the subject vehicle M. By using both the result of determination based on an image captured by the vehicle indoor camera 70 and the result of determination based on each load sensor 75, the vehicle occupant boarding determining unit 134, for example, inhibits erroneous determination of determining that a vehicle occupant has boarded in a state in which a load or the like is placed on a seat or the like, and accordingly, the accuracy of determination of boarding can be improved.

### [Function of Parking Driving Control Unit]

The parking driving control unit 142 executes parking control of determining a position at which the subject vehicle M is to be parked in the parking area PA1 on the basis of a result of recognition using the parking area recognizing unit 132 and a result of determination using the vehicle occupant boarding determining unit 134 and parking the subject vehicle M at the determined position.

For example, in a case in which the subject vehicle M is parked, the parking driving control unit 142 sets a parking completion state in a case in which it is determined by the vehicle occupant boarding determining unit 134 that a vehicle occupant has boarded the subject vehicle M to be different from a parking completion state in a case in which it is determined that a vehicle occupant has boarded the subject vehicle M. Here, the parking completion state, for example, is a state in which the parking of the subject vehicle M at a parking position has been completed and does not include a state in which parking control is started or parking control is in the middle of execution. For example, the parking driving control unit 142 sets a distance between a surrounding object and the subject vehicle M to be smaller than in a case it is determined that a vehicle occupant has boarded the subject vehicle M. A distance between a surrounding object and the subject vehicle M, for example, is a distance between at least one door among a plurality of doors Do1 to Do4 provided in the subject vehicle M and the surrounding object.

For example, in a case in which it is determined by the vehicle occupant boarding determining unit 134 that a vehicle occupant has boarded the subject vehicle M, the parking driving control unit 142 generates a target locus K1 along which the subject vehicle M is parked at a position at which the vehicle occupant can get in or out from all the doors Do1 to Do4 of the subject vehicle M. More specifically, for example, in a case in which the subject vehicle M is parked to the side of the side wall OB1, a target locus K1 causing the subject vehicle M to be parked at a position at which a distance D1 to the side wall OB1 becomes a distance for which a vehicle occupant can get in or out from the doors Do1 and Do2 is generated. On the other hand, in a case in which it is determined by the vehicle occupant boarding determining unit 134 that no vehicle occupant has boarded the subject vehicle M, the parking driving control unit 142 generates a target locus K1 causing the subject vehicle M to be parked at a position at which the distance D1 becomes a distance for which a vehicle occupant can get in or out from the doors Do1 and Do2. “A distance for which a vehicle occupant can get in or out” described above is an estimated distance for which a vehicle occupant cannot get in or out, and “a distance for which a vehicle occupant can get in or out” is an estimated distance for which a vehicle occupant cannot get in or out. The parking driving control unit 142 may set each of the distance for which a vehicle occupant can get in or out and the distance for which a vehicle occupant cannot get in or out to a fixed value in advance or may be set on the basis of shapes and sizes of the subject vehicle M and another vehicle, positions and sizes of doors, a direction in which each door is open or closed, a physical constitution of a vehicle occupant of the subject vehicle M captured by the vehicle indoor camera 70, and the like.

In this way, in a case in which it is determined that no vehicle occupant has boarded the subject vehicle M, by parking the subject vehicle M with at least some doors Do1 and Do2 among the doors Do1 to Do4 coming near to the side of the side wall OB1, it is difficult for a person to pass through the side of the doors Do1 and Do2, and it can be inhibited for a third party such as a suspicious person to open or close the door Do1 or Do2 by unlocking the key using an appropriate technique or break windows of the doors Do1 or Do2 (hereinafter, referred to as a theft behavior).

In a case in which the subject vehicle M is parked and in a case in which another vehicle is present in the parking area PA1 in which the subject vehicle is planned to be parked, the parking driving control unit 142 may adjust a distance to the another vehicle in a case in which the subject vehicle is parked with being disposed in parallel with the another vehicle on the basis of a result of recognition on whether the another vehicle is an automated driving vehicle or a non-automated driving vehicle. Here, a non-automated driving vehicle is a vehicle other than an automated driving vehicle and, for example, includes a vehicle caused to run through manual driving.

### [Function of Other Vehicle Determining Unit]

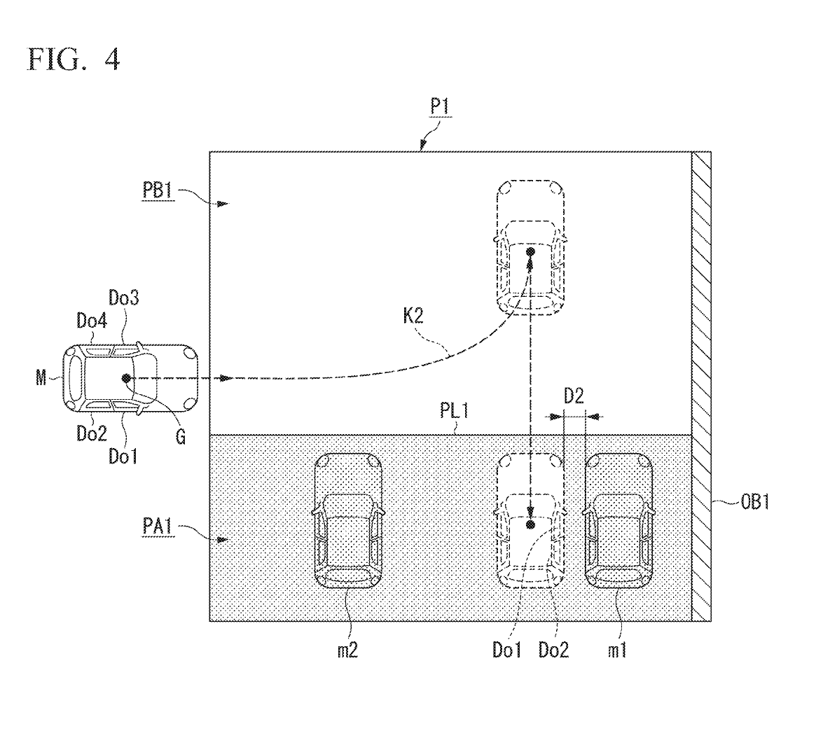

In a case in which another vehicle is present in the parking area PA1 in which the subject vehicle M is planned to be parked, the other vehicle determining unit 136 determines whether the another vehicle is an automated driving vehicle or a non-automated driving vehicle. FIG. 4 is a diagram showing a process of the other vehicle determining unit 136. In the example illustrated in FIG. 4, it is assumed that other vehicles m1 and m2 are parked in a parking area PA1.

For example, the other vehicle determining unit 136, transmits inquiry information for making an inquiry about whether the vehicle is an automated driving vehicle or a non-automated driving vehicle to the other vehicles m1 and m2 that have been parked in the parking area PA1 through the communication device 20. In a case in which the subject vehicle is planned to be parked with disposed in parallel with the other vehicle m1 out of the other vehicles m1 and m2 and in a case in which a distance between a planned parking position and the other vehicle m2 is estimated as a predetermined distance or more, the other vehicle determining unit 136 may transmit the inquiry information only to the other vehicle m1 without transmitting it to the other vehicle m2. Hereinafter, it is assumed that inquiry information is transmitted to the other vehicle m1.

The other vehicle determining unit 136 determines whether or not the other vehicle m1 is an automated driving vehicle or a non-automated driving vehicle on the basis of response information for the inquiry information transmitted from the other vehicle m1. In a case in which information indicating a non-automated driving vehicle is included in the response information from the other vehicle m1 or in a case in which response information from the other vehicle m1 has not been received even when a predetermined time has elapsed after transmission of the inquiry information, the other vehicle determining unit 136 determines that the other vehicle m1 is a non-automated driving vehicle. On the other hand, in a case in which information indicating an automated driving vehicle is included in the response information from the other vehicle ml, it is determined that the other vehicle m1 is an automated driving vehicle.

The other vehicle determining unit 136 may analyze an image captured by the camera 10 and determines whether the other vehicle m1 is an automated driving vehicle or a non-automated driving vehicle on the basis of feature information such as a color or a shape of the other vehicle m1. In such a case, the other vehicle determining unit 136 determines whether or not the feature information coincides with feature information of an automated driving vehicle and determines that the other vehicle m1 is an automated driving vehicle in the case of coincidence and determines that the other vehicle m1 is a non-automated driving vehicle in the case of no-coincidence. More specifically, for example, in a case in which it is determined that wheels and a steering wheel of the other vehicle m1 are housed inside the vehicle cabin or no windshield of the other vehicle m1 is present (in other words, a vehicle having no window), the other vehicle determining unit 136 determines that the other vehicle m1 is an automated driving vehicle.

The other vehicle determining unit 136 may identify a vehicle model of the other vehicle m1 on the basis of the feature information or the like and determine that the other vehicle m1 is an automated driving vehicle or a non-automated driving vehicle on the basis of the identified vehicle model. In such a case, in a case in which the identified vehicle model is a model of a vehicle in which only automated driving vehicles are manufactured, the other vehicle determining unit 136 determines that the other vehicle m1 is an automated driving vehicle.

In a case in which a vehicle occupant has not been boarded the subject vehicle M, and it is determined by the other vehicle determining unit 136 that the other vehicle ml is a non-automated driving vehicle, the parking driving control unit 142 sets a distance to the other vehicle M to be larger than in a case in which it is determined that the other vehicle is an automated driving vehicle. More specifically, in a case in which the other vehicle m1 is an automated driving vehicle, the parking driving control unit 142 generates a target locus K2 causing the subject vehicle M to be parked at a position at which a distance D2 to the another vehicle m1 becomes a distance for which a vehicle occupant cannot board from the doors Do1 and Do2 of the right side of the subject vehicle M. Then, as a result of parking of the subject vehicle M along the target locus K2, a state in which a person cannot get in or out the another vehicle m1 even from the door of the left side of the another vehicle m1 is formed. Accordingly, a theft behavior or the like of a third party from the doors Do1 and Do2 and the doors of the left side of the another vehicle m1 can be inhibited.

On the other hand, in a case in which the another vehicle m1 is a non-automated driving vehicle, the parking driving control unit 142 generates a target locus K2 for causing the subject vehicle M to be parked at a position at which a distance D2 to the another vehicle m1 becomes a distance for which a vehicle occupant can get in or out from a door of the left side of the another vehicle m1. In this way, in a case in which no vehicle occupant has boarded the subject vehicle M, the parking position is adjusted on the basis of whether the another vehicle m1 is an automated driving vehicle or a non-automated driving vehicle, and accordingly, the subject vehicle M can be parked at a more appropriate parking position

As described above, instead of (or in addition to) a result of recognition on whether the another vehicle m1 is an automated driving vehicle or a non-automated driving vehicle, the parking driving control unit 142 may adjust a distance to the another vehicle m1 on the basis of a result of determination on whether or not a vehicle occupant has boarded the another vehicle m1. In such a case, the parking driving control unit 142 makes an inquiry about whether or not a vehicle occupant has boarded through communication with the another vehicle m1, and, in a case in which it is determined that a vehicle occupant has boarded on the basis of a result of a response thereto, causes the subject vehicle M to be parked at a position at which the distance D2 becomes a distance for which a vehicle occupant can get in or out from a door of the another vehicle m1. Accordingly, it can be inhibited that a vehicle occupant of the another vehicle m1 cannot get off at the parked position.

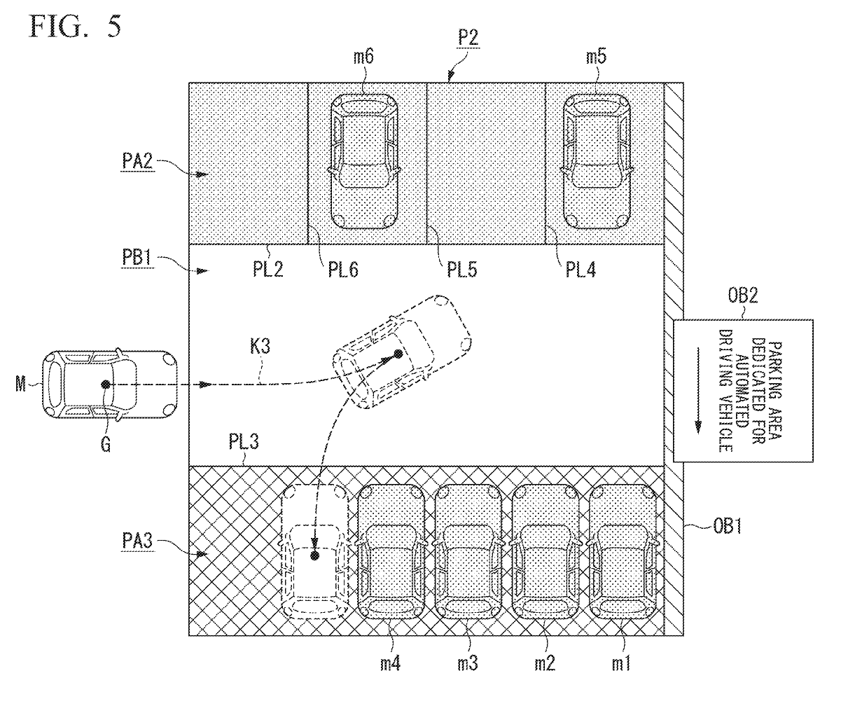

In a case in which a parking area dedicated for automated driving vehicles is disposed in a parking lot, the parking driving control unit 142 may cause the subject vehicle M to be parked at the parking area dedicated for automated driving vehicles preferentially over the other parking areas. FIG. 5 is a diagram showing a process of the parking driving control unit 142 causing the subject vehicle M to be parked in a parking area dedicated for automated driving vehicles. In the example shown in FIG. 5, a parking area PA2 in which an automated driving vehicle or a non-automated driving vehicle can be parked, a parking area PA3 dedicated for automated driving vehicles, and a non-parking area PB1 are assumed to be included in a parking lot P2. In the example shown in FIG. 5, a parking area and a non-parking area are partitioned using partition lines PL2 and PL3, and a parking interval for each vehicle is partitioned in a parking area PA2 using partition lines PL4 to PL6. A side wall OB1 is disposed in at least a part of the outer peripheral part of the parking lot P2. It is assumed that other vehicles ml to m4 are automated driving vehicles, and other vehicles m5 and m6 are non-automated driving vehicles.

For example, in a case in which the parking area PA3 dedicated for automated driving vehicles is recognized on the basis of a sign board OB2 disposed inside the parking lot P2 or the side wall OB1, characters drawn on the road surface inside the parking lot P2, or the like using the parking area recognizing unit 132, the parking driving control unit 142 generates a target locus K3 for causing the subject vehicle to be parked in the parking area PA3 dedicated for automated driving vehicles. The second control unit 160 causes the subject vehicle to be parked on the side of the another vehicle m4 by causing the subject vehicle M to run along the target locus K3. In this way, in a case in which the parking area PA3 dedicated for automated driving vehicles is present in the parking lot P2 in which the subject vehicle is planned to be parked, by causing the subject vehicle M to be parked preferentially therein, and accordingly, more vehicles can be parked in the parking area PA3 than in the parking area PA2. Since there is no space between vehicles parked in the parking area PA3 that is used for a vehicle occupant to get in or out, a theft behavior of a third party for each vehicle can be inhibited.

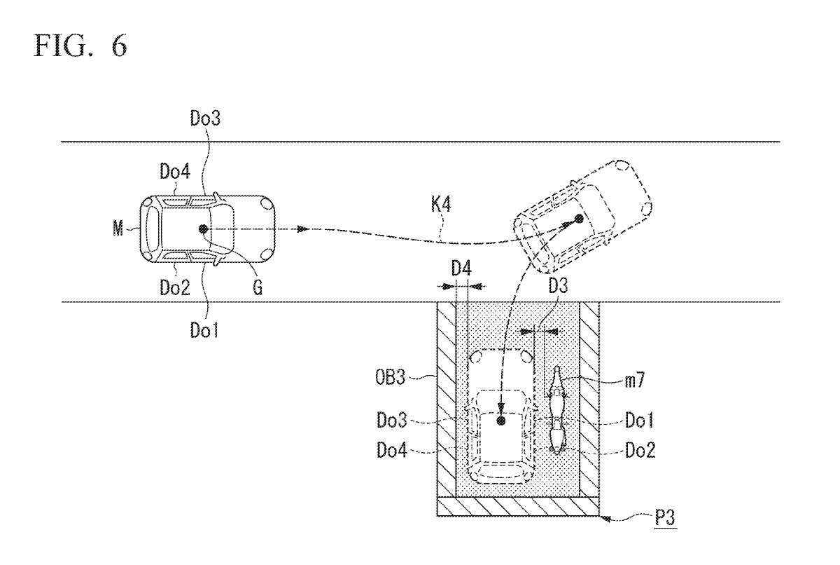

In a case in which the subject vehicle is parked at a garage of a house or the like, the parking driving control unit 142 may set a parking completion state to be different in accordance with whether or not a vehicle occupant has boarded the subject vehicle M. FIG. 6 is a diagram showing a process of the parking driving control unit 142 for causing the subject vehicle M to be parked in a garage. In the example shown in FIG. 6, it is assumed that another vehicle m7, which is a two-wheel vehicle, has already been parked inside a garage P3.

In a case in which the subject vehicle M is parked inside the garage P3, the parking driving control unit 142 determines whether or not there is a space for parking the subject vehicle M on the basis of a position of the another vehicle m7 inside the garage P3 that is recognized by the parking area recognizing unit 132. In this case, the parking driving control unit 142 sets a distance D3 to the another vehicle m7 in a case in which no vehicle occupant has boarded the subject vehicle M to be shorter than a distance in a case in which a vehicle occupant has boarded the subject vehicle M. The parking driving control unit 142 sets a distance D4 to the wall OB3 of the garage P3 in a case in which no vehicle occupant has boarded the subject vehicle M to be shorter than a distance in a case in which a vehicle occupant has boarded the subject vehicle M. More specifically, the parking driving control unit 142 generates a target locus K4 for causing the subject vehicle to be parked at a position for which a vehicle occupant cannot get in or out from doors Do1 to Do4. Accordingly, a theft behavior or the like of a third party for the subject vehicle M parked inside the garage P3 can be suppressed. In a case in which a vehicle occupant has boarded inside the subject vehicle M, the parking driving control unit 142 may generate a target locus K4 causing the subject vehicle M to be parked such that at least one or both of the distance D3 and the distance D4 becomes a distance for which a vehicle occupant can get in or out from the doors Do1 to Do4. In a case in which a vehicle occupant has boarded inside the subject vehicle M, in a case in which the subject vehicle cannot be parked at a position for which a vehicle occupant cannot get in or out from the doors Do1 to Do4 regarding at least one or both of the distances D3 and D4, the parking driving control unit 142 may perform control of switching from automated driving to manual driving by notifying information representing an indication thereof to the vehicle occupant using the HMI 30.

### [Processing Flow]

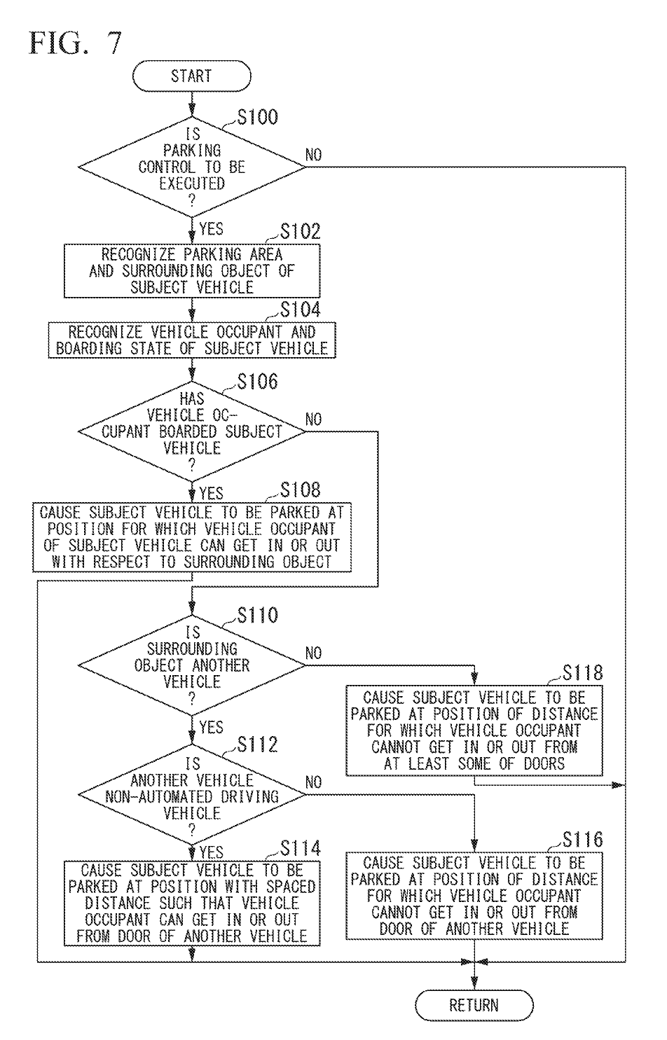

FIG. 7 is a flowchart showing the flow of a process executed by the automated driving control device 100 according to an embodiment. The process of this flowchart, for example, may be repeatedly executed at predetermined intervals or at a predetermined timing. When the process of this flowchart is started, it is assumed that a target locus is generated by the action plan generating unit 140, and automated driving is executed by the second control unit 160 on the basis of the generated target locus.

For example, during automated driving to a destination, the action plan generating unit 140 determines whether or not parking control of causing the subject vehicle M to be parked in a predetermined parking area is executed (Step S100). In a case in which it is determined that parking control is executed, the parking area recognizing unit 132 recognizes a parking area and a surrounding object of the subject vehicle (Step S102). Next, the vehicle occupant boarding determining unit 134 recognizes a state of a vehicle occupant having boarded the subject vehicle M (Step S104).

Next, the vehicle occupant boarding determining unit 134 determines whether or not a vehicle occupant has boarded the subject vehicle M (Step S106). In a case in which it is determined that a vehicle occupant has boarded the subject vehicle M, the parking driving control unit 142 causes the subject vehicle M to be parked at a position for which the vehicle occupant of the subject vehicle M can get in or out with respect to a surrounding object (Step S108). On the other hand, in a case in which it is determined that no vehicle occupant has boarded the subject vehicle M, the parking area recognizing unit 132 determines whether or not the recognized surrounding object is another vehicle (Step S110). In a case in which it is determined that the surrounding object is another vehicle, the other vehicle determining unit 136 determines whether or not the another vehicle is a non-automated driving vehicle (Step S112). In a case in which it is determined that the another vehicle is a non-automated driving vehicle, the parking driving control unit 142 causes the subject vehicle M to be parked at a position having a spaced distance such that the vehicle occupant can get in or out from a door of the another vehicle (Step S114). On the other hand, in a case in which the another vehicle is not a non-automated driving vehicle (in other words, in a case in which the another vehicle is an automated driving vehicle), the parking driving control unit 142 causes the subject vehicle M to be parked at a position of a distance for which a vehicle occupant cannot get in or out from the door of the another vehicle (Step S116). In other words, in the process of Step S114, a distance to the another vehicle is set to be larger than that in a case in which the another vehicle is recognized as an automated driving vehicle in the process of Step S116.

In the process of Step S110, in a case in which it is determined that the surrounding object is not another vehicle, the parking driving control unit 142 causes the subject vehicle M to be parked at a position for which a distance from the surrounding object becomes a distance for which a vehicle occupant cannot get in or out from at least some doors among a plurality of doors of the subject vehicle M (Step S118). In this way, the process of this flowchart ends. In the process of Step S100, even in a case in which it is determined that parking control is not executed, the process of this flowchart ends.

According to the embodiment described above, in a case in which the subject vehicle M is parked, more appropriate parking control can be executed on the basis of presence/absence of a boarding vehicle occupant. More specifically, according to the embodiment, the subject vehicle M is parked with a distance to a surrounding object adjusted on the basis of presence/absence of a boarding vehicle occupant, and accordingly, a theft behavior and the like of a third party for the subject vehicle M in the middle of parking can be inhibited.

### [Hardware Configuration]

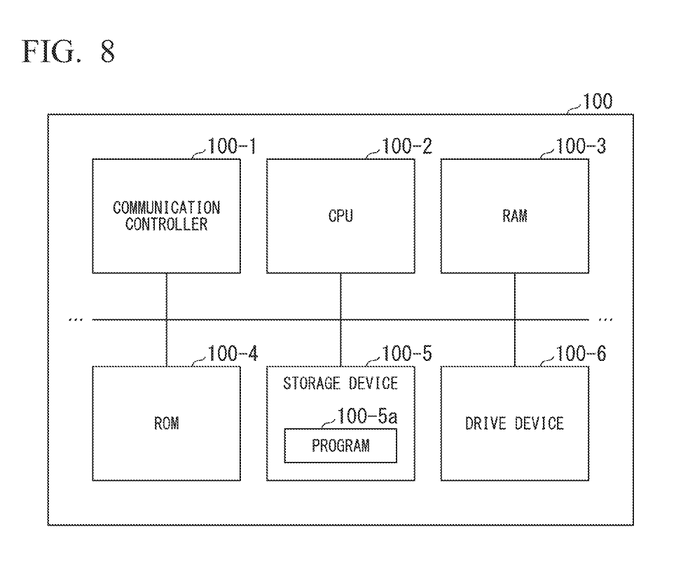

FIG. 8 is a diagram showing one example of the hardware configuration of the automated driving control device 100 according to an embodiment. As shown in the drawing, the automated driving control device 100 has a configuration in which a communication controller 100-1, a CPU 100-2, a RAM 100-3 used as a working memory, a ROM 100-4 storing a boot program and the like, a storage device 100-5 such as a flash memory or an HDD, a drive device 100-6, and the like are interconnected through an internal bus or a dedicated communication line. The communication controller 100-1 communicates with constituent elements other than the automated driving control device 100. In the drive device 100-6, a portable-type storage medium (for example, a computer-readable non-transitory storage medium) such as an optical disc is loaded. A program 100-5a executed by the CPU 100-2 is stored in the storage device 100-5. This program is expanded into the RAM 100-3 by a direct memory access (DMA) controller (not shown in the drawing) or the like and is executed by the CPU 100-2. In addition, the program 100-5a referred to by the CPU 100-2 may be stored in a portable-type storage medium loaded in the drive device 100-6 or may be downloaded from another device through a network. In this way, some or all of the first control unit 120 and the second control unit 160 of the automated driving control device 100 are realized.

The embodiment described above can be represented as below.

A vehicle control device including a storage device storing a program and a hardware processor and configured such that the hardware processor, by executing the program stored in the storage device, recognizes a surrounding situation of a subject vehicle and recognizes a state of a vehicle occupant having boarded the subject vehicle, controls steering and acceleration/deceleration of the subject vehicle on the basis of the recognized surrounding situation, and, in a case in which the subject vehicle is parked, sets a parking completion state in a case in which it is recognized that no vehicle occupant has boarded the subject vehicle to be different from a parking completion state in a case in which it is recognized that a vehicle occupant has boarded the subject vehicle.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognition unit that recognizes a surrounding situation of a subject vehicle and recognizes a state of a vehicle occupant having boarded the subject vehicle; and
a driving control unit that controls steering and acceleration/deceleration of the subject vehicle on the basis of the surrounding situation recognized by the recognition unit,
wherein, in a case in which the subject vehicle is parked, the driving control unit sets a parking completion state in a case in which it is recognized by the recognition unit that no vehicle occupant has boarded the subject vehicle to be different from a parking completion state in a case in which it is recognized by the recognition unit that a vehicle occupant has boarded the subject vehicle.

2. The vehicle control device according to claim 1, wherein, in a case in which it recognized that no vehicle occupant has boarded the subject vehicle in a case in which the subject vehicle is parked, the driving control unit sets a distance between a surrounding object recognized by the recognition unit and the subject vehicle to be shorter than in a case in which it is determined that a vehicle occupant has boarded the subject vehicle.

3. The vehicle control device according to claim 2, wherein the distance between the surrounding object and the subject vehicle is a distance between at least one door among a plurality of doors provided in the subject vehicle and the surrounding object.

4. The vehicle control device according to claim 1,
wherein the recognition unit recognizes whether another vehicle that is one of surrounding objects of the subject vehicle is an automated driving vehicle or a non-automated driving vehicle, and
wherein, in a case in which the subject vehicle is parked, the driving control unit sets a distance to the subject vehicle to be longer in a case in which it is recognized that no vehicle occupant has boarded the subject vehicle, and the another vehicle is a non-automated driving vehicle than in a case in which it is recognized that no vehicle occupant has boarded the subject vehicle, and the another vehicle is an automated driving vehicle.

5. A vehicle control method using a vehicle control device, the vehicle control method comprising:
recognizing a surrounding situation of a subject vehicle and recognizing a state of a vehicle occupant having boarded the subject vehicle;
controlling steering and acceleration/deceleration of the subject vehicle on the basis of the recognized surrounding situation; and
setting a parking completion state in a case in which it is recognized that no vehicle occupant has boarded the subject vehicle to be different from a parking completion state in a case in which it is recognized that a vehicle occupant has boarded the subject vehicle in a case in which the subject vehicle is parked.

6. A computer-readable non-transitory storage medium having a program stored thereon, the program causing a vehicle control device to execute:
recognizing a surrounding situation of a subject vehicle and recognizing a state of a vehicle occupant having boarded the subject vehicle;
controlling steering and acceleration/deceleration of the subject vehicle on the basis of the recognized surrounding situation; and
setting a parking completion state in a case in which it is recognized that no vehicle occupant has boarded the subject vehicle to be different from a parking completion state in a case in which it is recognized that a vehicle occupant has boarded the subject vehicle in a case in which the subject vehicle is parked.
